(19) United States
(12) Patent Application Publication
(10) Pub. No.: US 2025/0182603 A1
(43) Pub. Date: Jun. 5, 2025

(54) COMMUNICATION ALERT SYSTEM FOR UNAUTHORIZED POOL ENTRY

(71) Applicant: Acqua Angel, LLC, Sarasota, FL (US)

(72) Inventor: Paul Vegliante, Franklin Lakes, NJ (US)

(73) Assignee: Acqua Angel, LLC, Sarasota, FL (US)

(21) Appl. No.: 18/950,653

(22) Filed: Nov. 18, 2024

Related U.S. Application Data
(60) Provisional application No. 63/606,137, filed on Dec. 5, 2023.

(51) Int. Cl. G08B 21/08; G08B 25/00

(52) U.S. Cl. CPC G08B 21/08; G08B 25/00

(57) ABSTRACT

A communication alert system for unauthorized pool entry includes a detection system for detecting unauthorized pool ingress; and an alert system to notify neighbors proximal to a pool being monitored by the detection system. The alert system may include a pool safety system for receiving an alert or an alarm from the detection system and forwarding the alert or the alarm to the neighbors. A method for providing pool safety against unauthorized pool entry includes utilizing the communication alert system.

### CROSS-REFERENCE TO RELATED APPLICATIONS

This application claims the benefit of U.S. Provisional Application No. 63/606,137, filed Dec. 5, 2023, the contents of which is incorporated by reference herein.

### FIELD OF THE INVENTION

The present invention is directed to a communication alert system for unauthorized pool entry. In particular, the present invention is directed to a phone alert system notifying individuals, such as neighbors, proximal to a location of the pool for possible unauthorized entry into the pool.

### BACKGROUND OF THE INVENTION

Unauthorized entry into a pool may be by an adult, a teenager, an infant, and the like. Such unauthorized entry may require prompt action to avoid possible harm. For example, if an infant enters a pool without proximal supervision, the infant may be struggling against drowning.

Prompt action, on the order of minutes, may be necessary to avoid harm to the unauthorized individual in the pool. For example, a child may suffer brain damage within two to three minutes of breathing loss. Thus, prompt action is desirous to avoid undue injury from, for example, drowning.

Even if harm may not be immediately present, addressing unauthorized pool entry may prevent future potential harm, such as horseplay or misbehavior.

Thus, there is a need in the art for promptly addressing unauthorized pool entry.

### SUMMARY OF THE INVENTION

The present invention is directed to an alert system for promptly addressing unauthorized pool entry. Local neighbors may be alerted for unauthorized pool entry, and such neighbors may promptly entry the pool area typically in less time than required by local emergency services, such as police.

The neighbors will be able to respond faster than authorities, including local authorities or local emergency services. For example, replying on local authorities or local emergency services would typically require an alarm event being sent to a central monitoring station, who then calls or contacts local police dispatch and then who dispatches a message to a hopefully somewhat local patrol car. After all of these events, one hopes the police car is less than three minutes away to avoid injury from, for example, breathing loss for an individual unconscious in a pool. It is highly improbable that local police may be alerted and be onsite at the pool area as compared to neighbors being altered and onsite for the same event.

In one aspect of the present invention, a communication alert system for unauthorized pool entry is provided. The communication alert system may include a detection system for detecting unauthorized pool ingress, and an alert system to notify neighbors proximal to a pool being monitored by the detection system. The system may further include a pool safety system for receiving an alert or an alarm from the detection system and forwarding the alert or the alarm to the neighbors. The pool safety system may further forward the alert or the alarm to a local emergency service, a central monitoring service, or a home owner of the pool.

The detection system may be activated when pool supervision is required, such as when there is no personal supervisory presence at or near the pool. The system the detection system may be manually activated or may be remotely activated.

In another aspect of the present invention, a method for providing pool safety against unauthorized pool entry is provided. The method includes monitoring a pool for unauthorized entry and upon detecting unauthorized entry, alerting an entity of unauthorized pool entry. The entity may be a neighbor or a group of neighbors proximal to a location of the pool. The method may further include alerting a local emergency service of unauthorized pool entry, such as local police, local ambulance service, local emergency medical service, and combinations thereof. The method may also further include alerting a central monitoring service of unauthorized pool entry, such as a local security service or a home security monitoring service.

These and other features and advantages of the present invention will become apparent from the following detailed description of illustrative embodiments thereof, which is to be read in connection with the accompanying drawings. Corresponding reference element numbers or characters indicate corresponding parts throughout the several views of the drawings.

### BRIEF DESCRIPTION OF THE DRAWINGS

FIG. 1 is a schematic illustration of the communication alert system for unauthorized pool entry according to the present invention.

FIG. 2 is a flowchart illustrating the communication alert system for unauthorized pool entry according to the present invention.

FIG. 3 is a diagram illustrating hardware and software components capable of being utilized to implement the communication alert system.

### DETAILED DESCRIPTION OF THE INVENTION

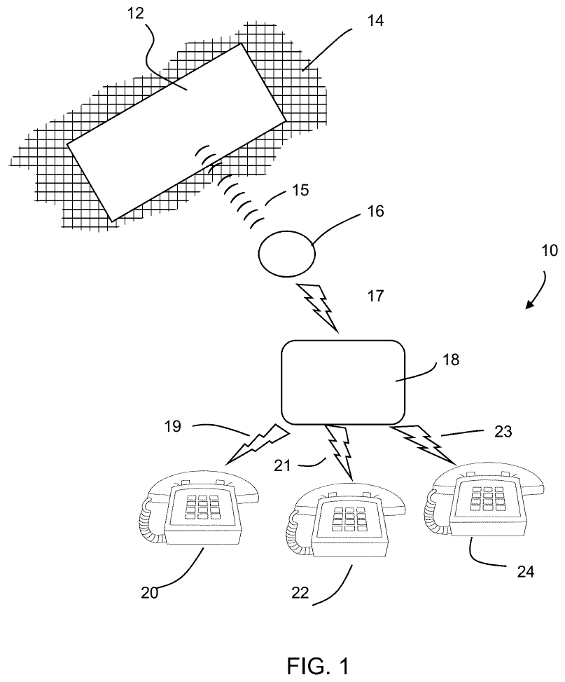

FIG. 1 is a schematic illustration of the communication, such as a phone, alert system 10 for unauthorized pool entry according to the present invention. As depicted in FIG. 1, the communication alert system 10 includes an unauthorized pool entry detection system 16 for monitoring entry into pool 12 and/or for monitoring ingress to deck portions 14 proximal to the pool 12. The detection system 16 may be remote from the pool 12 as depicted in FIG. 1. Such a remote detection system 16 may be a motion detector or other device capable of detecting unauthorized ingress to the pool 12 or even unauthorized ingress to proximal deck portions 14 by remote signaling 15.

The present invention, however, is not limited to a detection system that is remote from the pool, and a detection system directly associated with the pool and/or directly contained within, about, or above the pool may be used. For example, detection systems for unauthorized pool entry described in U.S. Pat. Nos. 10,810,857; 11,348,435; and 11,531,136, whose contents are incorporated herein by reference, including incorporated by reference in their entirety, may be used to detect unauthorized ingress with the communication alert system 10 of the present invention. Such systems may include, for example, an array of arrays of sensors proximally disposed at the pool to detect unauthorized pool entry.

The detection system 16 communicates with a pool safety system 18 via wireless signal 17 that unauthorized entry into the pool 12 and/or into the proximal deck portions 14 has been detected. The pool safety system 18 then alerts neighbors or even neighborhood watch personnel of such unauthorized entry. For example, the pool safety system 18 may alert a neighbor or neighbors via wireless signal 19 to a telephone 20 that is registered with the pool safety system 18 for the particular neighbor or neighbors. As neighbors are general close in proximity to the property having the pool 12, the neighbors could likely go to the pool 12 in just a few minutes, typically well before other central authorities are able to go the property having the pool 12. Such timing could be critical in saving a person in distress from, for example, drowning, who has entered the pool 12.

Where a plurality of neighbors or a plurality of neighborhood watch personnel are to be contacted, the pool safety system 18 may alert these pluralities concurrently or sequentially. For example, the alert may be forwarded all individuals or parties at the same or at substantially the same time. Alternatively, one party or individual or a small subset of the parties or individuals may be first contacted, followed by contacting the remaining parties or individuals. The pool safety system 18 may have a hierarchy associated with the contact list of parties agreeing to be included in the pool safety system 18. The parties closer to the location of the pool may be first contacted followed by contacting parties more remote from the location of the pool. The pool safety system 18 may also may have an alert acknowledgement to ascertain if a party contacted has affirmatively acknowledged receipt of the alert. Such acknowledgement may also include whether the party may or may not be able to access the pool location in a reasonable time. For example, if a contacted individual is not present at a normal proximal location to the pool, such as away from home for shopping, etc., that individual may so inform the pool safety system 18 so that priority contact may be given to other proximal individuals.

The pool safety system 18 may also notify a central monitoring service 22 via a wireless signal or alert 21 and/or may also notify local emergency services 24 via a wireless signal or alert 23. The wireless signal 19 to a neighbor or neighbors may be any convenient electronic device, for example a telephone 20 as depicted. The present invention, however, is not limited to contacting a neighbor or neighbors by telephone, and contact to other devices may also be used in addition to telephone contact. For example, contact to be to a computer, tables, pager, and the like.

The same holds for the central monitoring service 22 and/or the local emergency services 24, i.e., the contact may be via telephone or other devices. Local emergency services 24 may include local police, local ambulance service, local emergency medical services (EMS), and the like. The central monitoring service 22 may include local security services, home security monitoring services, and the like. Contact for these later services may be useful in providing further emergency care, if needed, to the distressed individual who has entered the pool 12.

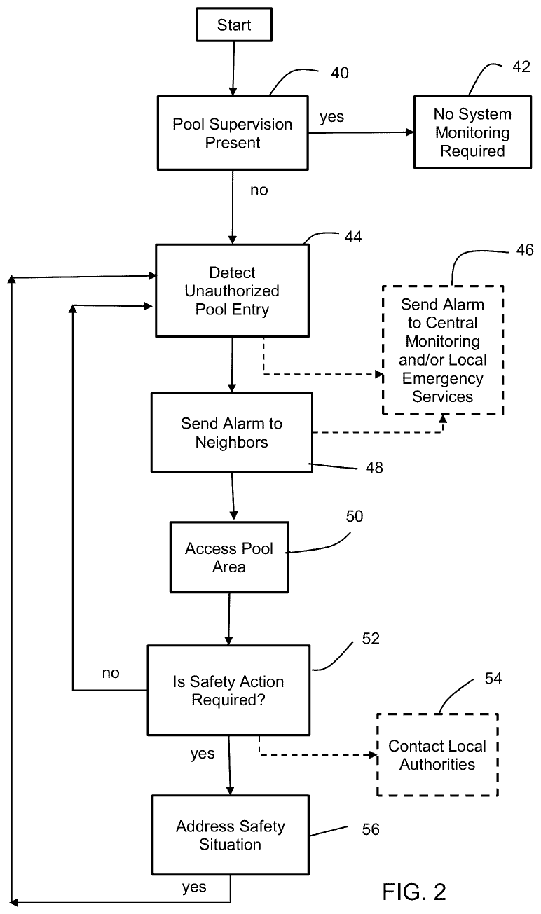

FIG. 2 is a flowchart illustrating the phone alert system 10 for unauthorized pool entry according to the present invention. At step 40, if pool supervision is present by, for example, a responsible adult, at the pool 12, then pool system monitoring the detection system 16 will likely not be required. If, however, no pool supervision is present, then the detection system 16 may be activated. The activation (not shown) may be manual by a responsible adult, such as a home owner, a renter, or even a visitor, for example by an activation switch, or even by remote signaling.

With the detection system 16 activated, when the detection system 16 detects unauthorized entry into the pool 12 at step 44, the detection system 16 may send an alarm or alert to neighbors at step 48. As described above such signaling is typically via the pool safety system 18. At step 46 an alarm or alert may also be optionally sent to central monitoring and/or local emergency services.

At step 50, neighbors may access the pool area. If the neighbors do not see or witness an unauthorized entry into the pool 12 and/or an individual in distress, then at step 52, no safety action is required and the detection system 16 may be returned from the alarm mode to the normal detection mode or back to step 44. If safety action is required at step 52, the neighbors may so provide. The neighbors may also contact local authorities, such as police or EMS, at step 54 either as a precaution or for further rendering assistance.

At step 56, if the safety situation is addressed, then the detection system 16 may be returned from an alarm mode to normal detection mode or back to step 44.

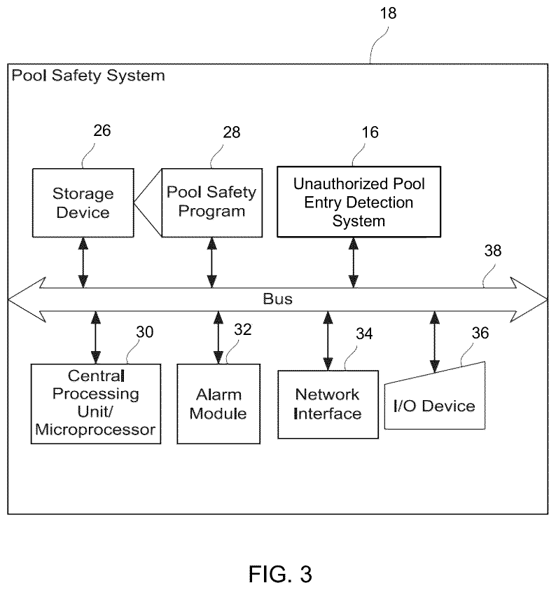

FIG. 3 is a diagram illustrating hardware and software components capable of being utilized to implement the pool safety system 18. The system 18 can include a communications bus 38, a storage device 26, pool safety code or program 28, an unauthorized pool entry detection system 16, a central processing unit (CPU) 30, an alarm module 32, a network interface 34, and one or more input devices 36 including, but not limited to, a keyboard, a mouse, etc.

The storage device 26 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.).

The functionality provided by the system 18 of the present disclosure could be provided by the pool safety program 28, which could be embodied as computer-readable program code stored on the storage device 26 and executed by the CPU 30 using any suitable, high or low level computing language, such as Python, Java, C, C++, C#, .NET, MATLAB, etc. Accordingly, execution of the pool safety program 28 is configured to control operation of the unauthorized pool entry detection system 16, and the alarm module 32. The alarm module 32 generates and an alarm message that can be transmitted to one or more of a remote device of a neighbor or neighbors, central monitoring services, local emergency services, a general user (home owner or renter), a home alarm system and the like.

The network interface 34 could include an Ethernet network interface device, a wireless network interface device, or any other suitable device which permits the system 18 to communicate via a network to a remote device of the user including, but not limited to, a personal computer, a server, a smart phone, tablet computer etc. The CPU 30 could include any suitable single-core or multiple-core microprocessor of any suitable architecture that is capable of implementing and running the pool safety program 28 (e.g., Intel processor).

While various embodiments of the present invention are specifically illustrated and/or described herein, it will be appreciated that modifications and variations of the present invention may be effected by those skilled in the art without departing from the spirit and intended scope of the invention. Further, any of the embodiments or aspects of the invention as described in the claims or in the specification may be used with one and another without limitation.

What is claimed is:

1. A communication alert system for unauthorized pool entry comprising:
a detection system for detecting unauthorized pool ingress; and
an alert system to notify neighbors proximal to a pool being monitored by the detection system.

2. The system of claim 1, further comprising a pool safety system for receiving an alert or an alarm from the detection system and forwarding the alert or the alarm to the neighbors.

3. The system of claim 2, wherein the pool safety system further forwards the alert or the alarm to a local emergency service.

4. The system of claim 2, wherein the pool safety system forwards the alert or the alarm to a central monitoring service.

5. The system of claim 2, wherein the pool safety system forwards the alert or the alarm to a home owner of the pool.

6. The system of claim 1, wherein the detection system is activated when pool supervision is required.

7. The system of claim 6, wherein the pool supervision is required when there is no personal supervisory presence at or near the pool.

8. The system of claim 6, wherein the detection system is manually activated.

9. The system of claim 6, wherein the detection system is remotely activated.

10. A method for providing pool safety against unauthorized pool entry, comprising:
monitoring a pool for unauthorized entry; and
upon detecting unauthorized entry, alerting an entity of unauthorized pool entry.

11. The method of claim 10, wherein the entity is a neighbor or a group of neighbors proximal to a location of the pool.

12. The method of claim 11, further comprising:
alerting a local emergency service of unauthorized pool entry.

13. The method of claim 12, wherein the local emergency service includes local police, local ambulance service, local emergency medical service, and combinations thereof.

14. The method of claim 11, further comprising:
alerting a central monitoring service of unauthorized pool entry.

15. The method of claim 14, wherein the local emergency service includes a local security service, a home security monitoring service, and combinations thereof.
